(19) United States
(12) Patent Application Publication
(10) Pub. No.: US 2012/0196156 A1
(43) Pub. Date: Aug. 2, 2012

(54) MAGNETIC TAPE

(75) Inventor: Ryota SUZUKI, Minami-ashigara-shi (JP)

(73) Assignee: FUJIFILM CORPORATION, Tokyo (JP)

(21) Appl. No.: 13/358,985

(22) Filed: Jan. 26, 2012

(30) Foreign Application Priority Data
Jan. 27, 2011 (JP) 2011-015683

(51) Int. Cl. G11B 5/708

(52) U.S. Cl. 428/844

(57) ABSTRACT

An aspect of the present invention relates to a magnetic tape comprising, on one surface of a nonmagnetic support, a nonmagnetic layer containing a nonmagnetic powder and a binder, and thereon, a magnetic layer containing a ferromagnetic powder and a binder, wherein
the magnetic layer contains a nonmagnetic filler the average particle diameter φ of which satisfies relation (I) below with a thickness t of the magnetic layer:

1.0≦φ/t≦2.0 (I);
the thickness t of the magnetic layer ranges from 30 to 200 nm;
the nonmagnetic layer has a thickness ranging from 30 to 200 nm;
a composite elastic modulus as measured on a surface of the magnetic layer ranges from 6.0 to 8.0 GPa; and
a centerline average surface roughness Ra of the surface of the magnetic layer, as measured by an optical three-dimensional profilometer, ranges from 0.2 to 1.5 nm.

### CROSS-REFERENCE TO RELATED APPLICATIONS

This application claims the benefit of priority under 35 USC 119 to Japanese Patent Application No. 2011-015683, filed on Jan. 27, 2011, which is expressly incorporated herein by reference in its entirety.

### BACKGROUND OF THE INVENTION

1. Field of the Invention

The present invention relates to a magnetic tape, and more particularly, to a magnetic tape affording both good electromagnetic characteristics and running durability.

2. Discussion of the Background

Hard disk recording density has continued to rise as the quantity of information has increased explosively in recent years. High-density recording is also considered necessary in the magnetic tapes that are used for backing up the increased information that is being recorded on hard disks and for long-term storage such as archive.

Microparticulate magnetic materials are widely employed and dispersed to a high degree in magnetic layers to achieve greater recording densities. The greater the degree to which the microparticulate magnetic material is dispersed, the fewer protrusions caused by magnetic material that are present on the surface of the magnetic layer, and thus the greater the surface smoothness of the magnetic layer. However, the greater the surface smoothness of the magnetic layer, the greater the coefficient of friction as the medium slides over the reproduction head and the greater the drop in running durability.

The surface profile of the magnetic layer can be controlled by adjusting the type and quantity of nonmagnetic fillers (such as carbon black and abrasives) added to the magnetic layer (for example, see Japanese Unexamined Patent Publication (KOKAI) No. 2004-103137, which is expressly incorporated herein by reference in its entirety). Japanese Unexamined Patent Publication (KOKAI) No. 2002-288816, which is expressly incorporated herein by reference in its entirety, proposes specifying the relation between the average particle size of the nonmagnetic filler in the magnetic layer and the thickness of the magnetic layer to control the roughness of the surface of the magnetic layer.

To enhance friction characteristics (lower the coefficient of friction) during signal reproduction in the conventional manner, it is effective to control the surface profile of the magnetic layer to reduce the contact surface area between the head and the medium. However, when the surface profile of the magnetic layer is controlled to enhance friction characteristics, a drop in electromagnetic characteristics may occur due to spacing variation.

Thus, conventionally there is a trade-off between friction characteristics and electromagnetic characteristics, making it difficult to achieve both.

### SUMMARY OF THE INVENTION

An aspect of the present invention provides for a magnetic tape affording both good electromagnetic characteristics and friction characteristics.

The present inventor conducted extensive research in that regard. As a result, he discovered that it can be achieved in a magnetic tape comprising, on one surface of a nonmagnetic support, a nonmagnetic layer containing a nonmagnetic powder and a binder, and thereon, a magnetic layer containing a ferromagnetic powder and a binder, in which (1) to (5) below are satisfied:

(1) the magnetic layer contains a nonmagnetic filler in which the average particle diameter φ and magnetic layer thickness t satisfy relation (I) below:

1.0≦φ/t≦2.0 (1);

(2) t (magnetic layer thickness) falls within a range of 30 to 200 nm;
(3) the thickness of the nonmagnetic layer falls within a range of 30 to 200 nm;
(4) the composite elastic modulus as measured on the surface of the magnetic layer falls within a range of 6.0 to 8.0 GPa; and
(5) the centerline average surface roughness Ra of the surface of the magnetic layer, as measured by an optical three-dimensional profilometer, falls within a range of 0.2 to 1.5 nm.

The particulars of how the present inventor discovered that a magnetic tape affording both good electromagnetic characteristics and friction characteristics could be obtained by satisfying (1) to (5) above are described below.

First, the present inventor formed a magnetic layer satisfying (1) and (2) above that made it possible to form effective protrusions on the surface of the magnetic layer to improve friction characteristics without compromising electromagnetic characteristics.

However, in a magnetic tape sequentially comprising a nonmagnetic layer and a magnetic layer on a nonmagnetic support, the portions beneath the magnetic layer (the nonmagnetic layer and below) greatly affected the spacing variation between the medium and the head. Accordingly, it was impossible to achieve both electromagnetic characteristics and friction characteristics by controlling just the magnetic layer. Accordingly, the present inventor conducted extensive research on factors affecting spacing variation. As a result, he discovered that both protrusions (short wavelength components) formed on the magnetic layer surface by filler in the magnetic layer and roughness of longer wavelength (long wavelength components), called “waviness,” were present on the surface of the magnetic layer. He discovered that the long wavelength components blocked the short wavelength components in the form of protrusions on the surface of the magnetic layer from coming into uniform contact with the head, and were a major factor in spacing variation.

Accordingly, the present inventor thought that waviness should be inhibited on the magnetic layer surface to achieve uniform contact between head and protrusions and reduce spacing variation. He thus limited the roughness that was measured by an optical three-dimensional profilometer ((5) above), corresponding to waviness.

Further, the present inventor discovered that if (1), (2), and (5) were satisfied, the coating layers on the magnetic layer side, including the magnetic layer and the nonmagnetic layer, desirably tended not to deform to the extent that effective protrusions could be formed on the surface of the magnetic layer. That was based on the fact that it was originally desirable for the coating layers on the magnetic layer side to tend not to undergo plastic deformation, newly discovered by the present inventor. Conventionally, coating layers on the magnetic layer side, particularly the nonmagnetic layer, have desirably been readily deformable to permit the elimination of roughness by calendering. Thus, the knowledge that it was desirable to form coating layers on the magnetic layer side that tended not to deform, particularly a nonmagnetic layer, clearly ran counter to conventional wisdom.

This point will be described in greater detail. The more readily coating layers on the magnetic layer side undergo plastic deformation, the more readily nonmagnetic filler in the magnetic layer is pushed to the nonmagnetic layer side, preventing it from serving as protrusions contributing to enhancing friction characteristics on the surface of the magnetic layer. Further, when magnetic tape is stored in roll form during the manufacturing process, and stored wound on a reel hub following manufacturing, protrusions on the reverse side of the medium (the reverse side of the support or the backcoat layer surface) are transferred to the surface of the magnetic layer, preventing elimination of the change in shape, and indentations (so-called “back transfer”) causing dropout tend to form on the surface of the magnetic layer.

Based on the above knowledge, the present inventor concluded that reducing portions undergoing plastic deformation so as to reduce plastic deformation to the extent that effective protrusions could form on the surface of the magnetic layer, that is, thinning the magnetic layer and the nonmagnetic layer ((3) above), and reducing the energy causing plastic deformation, that is, reducing the composite elastic modulus measured in the magnetic layer ((4) above), should be done in a magnetic tape. By contrast, the conventional wisdom holds that coating layers on the magnetic layer side, particularly the nonmagnetic layer, need to be thick enough to mask the profile of the surface beneath them, and should readily deform to permit the elimination of roughness by calendering. Thus, it would be conventionally difficult to discover the fact that it is actually desirable for coating layers on the magnetic layer side to tend not to undergo plastic deformation.

Based on the above circumstances, the present inventor discovered that it was possible to achieve both good electromagnetic characteristics and friction characteristics in a magnetic tape that satisfied (1) to (5) above. As set forth above, the present invention was arrived at only as a result of the present inventor conducting extensive trial and error based on technical thinking running counter to convention.

An aspect of the present invention relates to a magnetic tape comprising, on one surface of a nonmagnetic support, a nonmagnetic layer containing a nonmagnetic powder and a binder, and thereon, a magnetic layer containing a ferromagnetic powder and a binder, wherein

the magnetic layer contains a nonmagnetic filler the average particle diameter y of which satisfies relation (I) below with a thickness t of the magnetic layer:

1.0≦φ/t≦2.0 (I);

the thickness t of the magnetic layer ranges from 30 to 200 nm;

the nonmagnetic layer has a thickness ranging from 30 to 200 nm;

a composite elastic modulus as measured on a surface of the magnetic layer ranges from 6.0 to 8.0 GPa; and

a centerline average surface roughness Ra of the surface of the magnetic layer, as measured by an optical three-dimensional profilometer, ranges from 0.2 to 1.5 nm.

The nonmagnetic filler may be selected from the group consisting of an inorganic oxide particle and an organic polymer particle.

The nonmagnetic filler may be a colloidal particle.

The nonmagnetic filler may be a silica colloidal particle.

The magnetic layer may contain the nonmagnetic filler in a quantity ranging from 0.3 to 20 weight parts per 100 weight parts of the ferromagnetic powder.

The magnetic layer may further contain a granular substance which is different from the nonmagnetic filler.

The centerline average surface roughness Ra of the surface of the nonmagnetic support over which the magnetic layer is present, as measured by an optical three-dimensional profilometer, may range from 0.1 to 1.5 nm.

The magnetic tape may comprise a radiation-cured layer between the nonmagnetic layer and the nonmagnetic support.

The average particle size of the nonmagnetic powder contained in the nonmagnetic layer may range from 5 to 50 nm.

The binder contained in the nonmagnetic layer may comprise a functional group selected from the group consisting of a sulfonic acid group and a sulfonate group.

The concentration of the functional group of the binder contained in the nonmagnetic layer may range from 0.04 to 0.5 meq/g.

The magnetic tape may comprise a backcoat layer on the other surface of the nonmagnetic support.

The present invention can provide a magnetic tape with a low coefficient of friction during running, a good SNR, and a low error rate, that is, a magnetic tape affording both good friction characteristics and electromagnetic characteristics.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The present invention relates to a magnetic tape comprising, on one surface of a nonmagnetic support, a nonmagnetic layer containing a nonmagnetic powder and a binder, and thereon, a magnetic layer containing a ferromagnetic powder and a binder, in which (1) to (5) below are satisfied:

(1) the magnetic layer contains a nonmagnetic filler in which the average particle diameter φ and magnetic layer thickness t satisfy relation (I) below:

1.0≦φ/t≦2.0 (1);

(2) t (magnetic layer thickness) falls within a range of 30 to 200 nm;
(3) the thickness of the nonmagnetic layer falls within a range of 30 to 200 nm;
(4) the composite elastic modulus as measured on the surface of the magnetic layer falls within a range of 6.0 to 8.0 GPa; and
(5) the centerline average surface roughness Ra of the surface of the magnetic layer, as measured by an optical three-dimensional profilometer, falls within a range of 0.2 to 1.5 nm.

A summary of why the magnetic tape of the present invention can afford both good electromagnetic characteristics and friction characteristics by satisfying items (1) to (5) above has been set forth above. Each of items (1) to (5) will be described in greater detail below.

### Items (1) and (2)

In the magnetic tape of the present invention, the magnetic layer contains a nonmagnetic filler such that the average particle diameter φ and magnetic layer thickness t satisfy relation (I) below:

1.0≦φ/t≦2.0 (I).

The nonmagnetic filler can contribute to enhancing friction characteristics by suitably protruding from the surface of the magnetic layer. When the average particle diameter φ thereof is less than the thickness t of the magnetic layer, that is, when φ/t is less than 1.0, the nonmagnetic filler does not adequately protrude from the surface of the magnetic layer. As a result, when the head and magnetic layer surface slide against each other, the coefficient of friction increases and good electromagnetic characteristics are precluded. Additionally, when the average particle diameter φ of the nonmagnetic filler exceeds twice the thickness t of the magnetic layer, that is, when φ/t exceeds 2.0, the nonmagnetic filler protrudes excessively from the magnetic layer surface, becoming a spacing factor. Thus, electromagnetic characteristics deteriorate. Accordingly, in the present invention, the nonmagnetic filler with the average particle diameter satisfying relation (I) above with a thickness t of the magnetic layer is employed in the magnetic layer.

In the present invention, the average particle diameter of the nonmagnetic filler is a value measured by the following method.

Photographs of the particles of a nonmagnetic filler are printed on photographic paper with a transmission electron microscope. For example, a model H-9000 transmission electron microscope made by Hitachi can be used to photograph particles at a magnification of about 50,000-fold to about 100,000-fold and print the photograph on photographic paper to obtain a particle photograph.

Next, 50 particles are randomly extracted from the particle photograph, the contour of each particle is traced with a digitizer, and the diameter of a circle of identical area (the diameter corresponding to a circular area) to the traced region is calculated. In the present invention, the term “particle diameter of the nonmagnetic filler” refers to the diameter thus calculated. The image analysis software KS-400 made by Carl Zeiss can be employed to calculate particle diameters, for example. Further, a circle with a diameter of 1 cm, for example, can be used in scale correction in the course of incorporating images from the scanner and analyzing them.

The arithmetic average of the diameters of the 50 particles measured by the above method is adopted as the average particle diameter of the nonmagnetic powder. The same holds true for the average particle diameter of the granular substance contained in the magnetic layer, described further below. The particle size distribution of the nonmagnetic filler, described further below, is a value obtained from the average particle diameter and the standard deviation of the particle diameter of the 50 particles measured by the above method.

The average particle diameter that is obtained by the above method is an average value that is calculated from 50 primary particles. The term “primary particle” means an independent, non-aggregated particle. Accordingly, the sample particles that are used to measure the average particle diameter of the nonmagnetic filler can be sample powder collected from the magnetic layer or starting material powder so long as the diameter of the primary particles can be measured. Sample powder can be collected from the magnetic layer by the following method, for example.

### Method of Collecting Sample Powder

1. Treating the surface of the magnetic layer for 1 to 2 minutes with a plasma reactor made by Yamato Scientific Co., Ltd. and ashing and removing the organic components (binder component and the like) of the surface of the magnetic layer.

2. Adhering filter paper that has been immersed in an organic solvent such as cyclohexanone or acetone to the edge of a metal rod, rubbing the surface of the magnetic layer following the treatment of 1. above against it, and transferring by peeling the magnetic layer component from the magnetic recording medium to the paper.

3. Shaking the component that has peeled off in 2. above into a solvent such as cyclohexanone or acetone (placing each piece of filter paper in solvent and shaking it with an ultrasonic disperser), drying the solvent, and collecting the component that has peeled off.

4. Placing the component that has been scraped off in 3. above in a glass test tube that has been thoroughly washed, adding about 20 mL of n-butylamine to the magnetic layer component, and sealing the glass test tube (the n-butylamine is added in a quantity that is capable of breaking down the remaining binder that has not been ashed).

5. Heating the glass test tube at 170° C. for equal to or more than 20 hours to break down the binder and curing agent components.

6. Thoroughly washing with pure water and drying the precipitate following the decomposition of 5. above and collecting the powder.

Sample powder can be collected from the magnetic layer by the above steps.

In relation (I) above, the thicker the magnetic layer, the greater the presence of large nonmagnetic filler that is permitted. However, when the thickness of the magnetic layer exceeds 200 nm, the presence of coarse nonmagnetic filler that becomes a spacing factor is also permitted, and electromagnetic characteristics deteriorate. Accordingly, in the magnetic tape of the present invention, the thickness of the magnetic layer is equal to or less than 200 nm. When the magnetic layer is less than 30 nm in thickness, it is difficult to achieve adequate output and to form a uniform coating layer. Thus, the thickness of the magnetic layer is equal to or greater than 30 nm. That is, in the magnetic tape of the present invention, the thickness of the magnetic layer falls within a range of 30 nm to 200 nm. The thickness of each layer, including the magnetic layer, in the magnetic tape of the present invention can be calculated from the coating conditions (quantity of coating liquid applied, area of application, and the like). It can also be obtained by observing at a magnification of 500,000-fold, for example, an ultrathin slice of magnetic tape (10 μm in length, for example) by a transmission electron microscope (TEM).

In relation (I) above, to achieve better electromagnetic characteristics and friction characteristics, it is desirable for:

1.2≦φ/t≦1.7 (I)

and preferable for:

1.4≦φ/t≦1.7 (I).

The average particle diameter of the nonmagnetic filler need only satisfy relation (I) above. It desirably falls within a range of 50 to 200 nm to obtain even better electromagnetic characteristics. From the perspective of obtaining still better electromagnetic characteristics, the thickness of the magnetic layer is desirably equal to or less than 170 nm. From the perspective of forming a more uniform magnetic layer, it is desirably equal to or greater than 50 nm.

So long as the nonmagnetic filler satisfies relation (I) above, it can be an organic or inorganic material. From the perspective of the availability of particles of good size distribution and dispersibility, the nonmagnetic filler is desirably selected from the group consisting of inorganic particles and organic polymer particles. To obtain better electromagnetic characteristics and friction characteristics, the coefficient of variation in the particle size distribution ((standard deviation of particle diameter/average particle diameter)×100) is desirably equal to or less than 40 percent, preferably equal to or less than 20 percent. To form desired protrusions on the surface of the magnetic layer, organic polymer particles with poor solubility in the organic solvent employed to prepare the magnetic layer coating liquid (ketone solvents such as methyl ethyl ketone, methyl isobutyl ketone, and cyclohexanone; alcohol solvents such as methanol, ethanol, and isopropyl alcohol; toluene; and the like) are desirably employed. From this perspective, examples of desirable organic polymer particles are those with structural components in the form of at least one component selected from among acrylic, styrene, divinylbenzene, benzoguanamine, melamine, formaldehyde, butadiene, acrylonitrile, chloroprene, and fluoropolymers. Organic polymer particles comprising a structural component in the form of at least one component selected from the group consisting of acrylic, styrene, divinylbenzene, benzoguanamine, melamine, formaldehyde, butadiene, acrylonitrile, and chloroprene are desirable. Polymer particles containing acrylic, styrene, or divinylbenzene are preferred. And polymer particles containing acrylic or styrene are of greater preference. These can be prepared by known methods. They are also available as commercial products. Examples of commercially available organic polymer particles are methacrylic acid copolymer particles, crosslinked acrylic particles, and crosslinked polystyrene particles made by Soken Chemical and Engineering Co., Ltd.; crosslinked acrylic particles made by Sekisui Chemical Co., Ltd.; and melamine-formaldehyde condensate particles made by Nippon Shokubai Co., Ltd. Examples of specific commercial products are Chemisnow made by Soken Chemical and Engineering Co., Ltd.; Advancell made by Sekisui Chemical Co., Ltd.; and Epostar made by Nippon Shokubai.

Examples of inorganic materials that are suitable for constituting the nonmagnetic filler are metal oxides, metal carbonates, metal sulfates, metal nitrides, metal carbides, and metal sulfides. Inorganic oxides are desirable. One or a combination of two or more from among α-alumina with an α-conversion rate of equal to or greater than 90 percent, β-alumina, γ-alumina, θ-alumina, silicon dioxide, silicon carbide, chromium oxide, cerium oxide, alpha-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide can be employed as inorganic oxides. From the perspective of the availability of particles affording good dispersibility, silica (silicon dioxide) is desirable.

From the perspective of dispersibility, colloidal particles are desirably employed as the nonmagnetic filler. From the perspective of availability, inorganic colloidal particles are desirable and inorganic oxide colloidal particles are preferred. Colloidal particles of the above-listed inorganic oxides are examples of the inorganic oxide colloidal particles. Specific examples include complex inorganic oxide colloidal particles in the form of SiO₂.Al₂O₃, SiO₂.B₂O₃, TiO₂.CeO₂, SnO₂.Sb₂O₃, SiO₂.Al₂O₃.TiO₂, and TiO₂.CeO₂:SiO₂. Desirable examples are inorganic oxide colloidal particles such as SiO₂, Al₂O₃, TiO₂, ZrO₂, and Fe₂O₃. From the perspective of the availability of monodisperse colloidal particles, silica colloidal particles (colloidal silica) is preferred.

Since colloidal particles generally have hydrophilic surfaces, they are suited to the preparation of colloidal liquids employing water as the dispersion medium. For example, colloidal silica obtained by the usual synthesis methods has a surface that is covered with polarized oxygen atoms (O²⁻), and will thus adsorb to water when in water, forming hydroxyl groups and stabilizing. However, these particles tend not to remain in the form of a colloid when placed in an organic solvent employed in the coating liquid of a magnetic tape. Accordingly, the surface of the particles is treated to render it hydrophobic to permit dispersion of these particles in the form of a colloid in organic solvents. Such colloidal particles that have been treated to render them hydrophobic are desirably employed in the present invention, as well. The details of such hydrophobic treatments are given in, for example, Japanese Unexamined Patent Publication (KOKAI) Heisei Nos. 5-269365 and 5-287213, and Japanese Unexamined Patent Publication (KOKAI) No. 2007-63117, which are expressly incorporated herein by reference in their entirety. Colloidal particles that have been subjected to such a surface treatment can be synthesized by the methods described in the above-cited publications and the like, or procured as commercial products.

An example of a method of preparing the coating liquid for forming the magnetic layer using the above colloidal particles is mixing a first liquid (magnetic liquid) containing a ferromagnetic powder, a binder and an organic solvent with a second liquid (colloidal liquid) containing colloidal particles. As will be set forth further below, when adding an abrasive to the magnetic layer, the abrasive can be added to at least either the first or second liquid. It is also possible to separately prepare a liquid (abrasive liquid) containing the abrasive and an organic solvent and mix the abrasive liquid with the first and second liquids.

Any proportion of acetone, methyl ethyl ketone, methyl isobutyl ketone, diisobutyl ketone, cyclohexanone, isophorone, tetrahydrofuran, and other ketones; methanol, ethanol, propanol, butanol, isobutyl alcohol, isopropyl alcohol, methylcyclohexanol, and other alcohols; methyl acetate, butyl acetate, isobutyl acetate, isopropyl acetate, ethyl lactate, glycol acetate, and other esters; glycol dimethyl ether, glycol monoethyl ether, dioxane, and other glycol ethers; benzene, toluene, xylene, cresol, chlorobenzene, and other aromatic hydrocarbons; methylene chloride, ethylene chloride, carbon tetrachloride, chloroform, ethylene chlorohydrin, dichlorobenzene, and other chlorinated hydrocarbons; N,N-dimethyl formamide; and hexane can be employed as the organic solvent employed to prepare the coating liquid for forming the magnetic layer. The organic solvent does not necessarily have to be 100 percent pure. It may contain isomers, unreacted matter, by-products, decomposition products, oxides, moisture, and other impurities. The impurities desirably constitute equal to or less than 30 weight percent, preferably equal to or less than 10 weight percent. To enhance dispersibility, a somewhat high degree of polarity is desirable. Within the solvent composition, a solvent with a dielectric constant of equal to or greater than 15 desirably constitutes for equal to or more than 50 weight percent. Further, a dissolution parameter of 8 to 11 is desirable. From these perspectives, examples of desirable organic solvents are methyl ethyl ketone, cyclohexanone, and mixed solvents thereof in any ratio.

The organic solvent employed in the magnetic liquid and the organic solvent employed in the colloidal liquid can be selected as desired from the above-listed organic solvents. To maintain a stable colloidal state when mixing the magnetic liquid and the colloidal liquid, it is desirable for the organic solvent contained in the magnetic liquid to be compatible with the organic solvent contained in the colloidal liquid. The compatibility referred to in the present invention means that two solvents can be uniformly mixed to a degree where they do not appear to separate into two or more liquids when visually observed. From this perspective, the solvent employed in the magnetic liquid and the solvent employed in the colloidal liquid are desirably selected from among methyl ethyl ketone, cyclohexanone, and mixed solvents thereof, which were given above as examples of desirable organic solvents. In that case, the solvent of the abrasive liquid is also desirably selected from among methyl ethyl ketone, cyclohexanone, and mixed solvents thereof. The concentration of the colloidal particles in the colloidal liquid is, for example, about 5 to 50 weight percent. However, it is not specifically limited so long as it allows the nonmagnetic particles to remain stably present in colloidal form.

The content of the nonmagnetic filler in the magnetic layer is not specifically limited other than it be set within a range permitting both good electromagnetic characteristics and friction characteristics. It is desirably 0.3 to 20 weight parts, preferably 0.5 to 5 weight parts, more preferably, 1 to 3 weight parts, per 100 weight parts of ferromagnetic powder.

Additional details relating to the magnetic layer of the magnetic tape of the present invention will be given further below.

### Items (3) and (4)

As set forth above, the thicker the nonmagnetic layer, the more portions undergoing plastic deformation there will be, and thus the greater the increase in the coefficient of friction due to the sinking of nonmagnetic filler from the magnetic layer into the nonmagnetic layer and the greater the dropout due to back transfer there will be. When the thickness of the nonmagnetic layer exceeds 200 nm, there is pronounced deterioration of electromagnetic characteristics and friction characteristics due to these effects. Thus, the thickness of the nonmagnetic layer is set to equal to or less than 200 nm in the present invention. However, the formation of a uniform coating layer becomes difficult when the thickness of nonmagnetic layer is less than 30 nm. Thus, the thickness of the nonmagnetic layer is set to equal to or greater than 30 nm. That is, the thickness of the nonmagnetic layer in the magnetic tape of the present invention falls within a range of 30 to 200 nm. From the perspective of forming a more uniform nonmagnetic layer, the thickness of the nonmagnetic layer is desirably equal to or greater than 50 nm, and from the perspective of further reducing plastic deformation, the thickness of the nonmagnetic layer is equal to or less than 150 nm, preferably equal to or less than 100 nm.

In the present invention, the thickness of the nonmagnetic layer is set to within a range of 30 to 200 nm as a means of decreasing plastic deformation of the nonmagnetic layer. Moreover, in the present invention, the composite elastic modulus as measured on the surface of the magnetic layer is set to a range of 6.0 to 8.0 GPa. That can reduce the plastic deformation of coating layers (the magnetic layer, nonmagnetic layer, and the like) on the magnetic layer side and achieve both the formation of effective protrusions on the magnetic layer surface and a reduction in back transfer. When the composite elastic modulus is less than 6.0 GPa, the nonmagnetic filler in the magnetic layer sinks into the nonmagnetic layer without returning and does not remain on the surface of the magnetic layer as effective protrusions. When 8.0 GPa is exceeded, certain phenomena end up occurring, such as back transfer causing dropout becoming pronounced and protrusions not suitably sinking during running and thus raising the coefficient of friction. From the perspective of achieving both improved friction characteristics and reduced dropout, the composite elastic modulus desirably falls within a range of 6.3 to 7.8 GPa, preferably within a range of 6.5 to 7.6 GPa.

In the present invention, the term “composite elastic modulus” refers to the composite elastic modulus that is evaluated using a Tribo Indenter made by Hysitron Inc. by using a spherical diamond indenter (tip R: 1.3 μm) to make a single pressing measurement of the magnetic layer surface (surface of coating layers on the magnetic layer side). The composite elastic modulus is obtained by the Hertz contact solution shown in equation 1 below.

$$P = \frac{4}{3} \sqrt{R} {E}_{r} {h}^{3 / 2} \qquad ( 1 )$$

In the above equation, P denotes the pressing load, R denotes the radius of the spherical indenter, h denotes the pressing depth, and Er denotes the composite elastic modulus. The average value of three measurements at a pressing (unloading) time of 11 seconds up to the maximum pressing depth for a maximum pressing depth of 100 nm is adopted as the composite elastic modulus measured on the magnetic layer surface.

The composite elastic modulus measured on the surface of the magnetic layer can be controlled by the following methods, for example:

(A) Selection of the binders employed in the magnetic layer and nonmagnetic layer.
(B) Adjustment of the size and quantity of carbon black mixed into the magnetic layer and nonmagnetic layer.
(C) Adjustment of the mixing ratio of the binder and main powders (ferromagnetic powder and nonmagnetic powder) in the magnetic layer and nonmagnetic layer.
(D) Adjustment of the size of the ferromagnetic powder and nonmagnetic powder.
(E) Formation of an undercoating layer between the nonmagnetic layer and nonmagnetic support.
(F) Adjustment of the mechanical characteristics (such as the Young's modulus) of the nonmagnetic support.

As set forth above, the composite elastic modulus that is measured on the surface of the magnetic layer can be controlled in the magnetic layer and nonmagnetic layer. However, the magnetic layer, which determines the magnetic characteristics, is limited in terms of characteristics. Thus, control of the elastic modulus is desirably achieved primarily on the nonmagnetic layer side. Among (A) to (F) above, the impact of factors relating to voids in the nonmagnetic layer is high. Specifically, the size of the nonmagnetic powder in the nonmagnetic layer, the mixing ratio of nonmagnetic powder to binder, the types and quantities of polar groups of the binder in the nonmagnetic layer, and the size and mixing ratio of carbon black, and the like have major effects. When the average particle size of the nonmagnetic powder is about 5 to 50 nm, the voids in the nonmagnetic layer can decrease in number and size, thereby raising the elastic modulus. Both the size and quantity of carbon black added relate to voids. Generally, as the size of carbon black increases, it becomes easier to disperse, the number of voids in the nonmagnetic layer decreases, and the composite elastic modulus rises. The average particle diameter of the carbon black is desirably 10 to 50 nm, preferably 10 to 40 nm. Additionally, when little carbon black is added, it becomes easier to disperse, the number of voids in the nonmagnetic layer decreases, and the composite elastic modulus rises. It is also effective to employ known binders with high elastic moduli. When the binder that is contained in the nonmagnetic layer permits a high degree of dispersion of granular substance such as nonmagnetic powder and carbon black, the number of voids in the nonmagnetic layer can decrease and the composite elastic modulus can rise. Examples of binders that are desirable in this regard are those containing sulfonic acid (salt) groups (the concentration of sulfonic acid (salt) groups desirably being 0.04 to 0.5 meq/g). In the present invention, the term “sulfonic acid (salt) group” is used to include the sulfonic acid group (—SO₃H) and sulfonate groups (such as —SO₃Na and —SO₃K).

A radiation-cured layer formed by irradiating with radiation a radiation-curable composition containing a radiation-curable resin or radiation-curable compound is desirable as the undercoating layer of (E) above. The composite elastic modulus can be controlled by means of the thickness and formula of the radiation-cured layer.

By taking the above points into account and combining (A) to (F) as desired in the present invention, it is possible to keep to within the desired range the composite elastic modulus as measured on the magnetic layer surface.

### Item (5)

In the present invention, in addition to satisfying (1) to (4) above, the centerline average surface roughness Ra of the surface of the magnetic layer as measured by an optical three-dimensional profilometer is set to 0.2 to 1.5 nm. When the Ra of the magnetic layer surface exceeds 1.5 nm, an increase in spacing variation compromises electromagnetic characteristics. The lower Ra is the better from the perspective of controlling spacing variation. However, achieving a level of less than 0.2 nm is difficult with existing manufacturing technology. Thus, in the present invention, the lower limit of Ra is set to 0.2 nm. From the perspective of further inhibiting spacing variation, Ra is desirably equal to or lower than 1.0 nm, preferably equal to or lower than 0.6 nm.

In the present invention, the centerline average surface roughness Ra as measured by an optical three-dimensional profilometer refers to the centerline average surface roughness Ra measured for an area of 350 μm by 260 μm on the surface being measured using a non-contact optical profilometer (device: New View 5022 made by Zygo) with a 20-fold object lens.

Examples of the structure of the magnetic tape of the present invention are an embodiment in which the nonmagnetic layer is directly formed on a nonmagnetic support and an embodiment in which an undercoating layer is formed between the nonmagnetic layer and the nonmagnetic support. In the former case, to control Ra, it is desirable to employ a nonmagnetic support with reduced waviness, specifically, a nonmagnetic support having a surface, on which a nonmagnetic layer is present, with a centerline average surface roughness Ra as measured by an optical three-dimensional profilometer falling within a range of 0.1 to 1.5 nm. Such supports are available as commercial products and can be produced by known manufacturing methods by adjusting the manufacturing conditions. In the latter case, it is desirable to form an undercoating layer using a radiation-curable resin with a high leveling effect on the surface of a nonmagnetic support with a centerline average surface roughness Ra as measured by an optical three-dimensional profilometer falling within a range of 0.1 to 2.5 nm, preferably 0.1 to 1.5 nm.

The magnetic tape of the present invention satisfies items (1) to (5) above and thus can achieve both good electromagnetic characteristics and friction characteristics.

The magnetic tape of the present invention will be described in greater detail below.

### Magnetic Layer

(i) Ferromagnetic Powder

Hexagonal ferrite powders and ferromagnetic metal powders are examples of the ferromagnetic powder contained in the magnetic layer.

The average particle size of the ferromagnetic powder can be measured by the following method.

Particles of ferromagnetic powder are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured. The average value of the particle sizes measured by the above method is adopted as an average particle size of the ferromagnetic powder.

The size of a powder such as the ferromagnetic powder described further below (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter). In the measurement of powder size, the standard deviation/average value, expressed as a percentage, is defined as the coefficient of variation.

Examples of hexagonal ferrite powders are barium ferrite, strontium ferrite, lead ferrite, calcium ferrite, and various substitution products thereof such as Co substitution products. The average plate diameter of the hexagonal ferrite powder preferably ranges from 10 to 100 nm, more preferably 10 to 60 nm, further preferably 10 to 50 nm. Particularly when employing an MR head in reproduction to increase a track density, an average plate diameter equal to or less than 60 nm is desirable to reduce noise, with equal to or less than 50 nm being preferred. An average plate diameter equal to or higher than 10 nm can yield stable magnetization without the effects of thermal fluctuation. An average plate diameter equal to or less than 100 nm can permit low noise and is suited to the high-density magnetic recording. The hexagonal ferrite powder employed in the present invention preferably has a coercivity (Hc) ranging from 2,000 to 4,000 Oe (about 160 to 320 kA/m). For details of the hexagonal ferrite powder suitable for use in the present invention, reference can be made to paragraphs [0034] to [0037] of Japanese Unexamined Patent Publication (KOKAI) No. 2009-54270, which is expressly incorporated herein by reference in its entirety.

The ferromagnetic metal powder employed in the magnetic layer is not specifically limited, but preferably a ferromagnetic metal powder comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The specific surface area by BET method of the ferromagnetic metal powder employed in the magnetic layer is preferably 45 to 100 m²/g, more preferably 50 to 80 m²/g. At 45 m²/g and above, low noise can be achieved. At 100 m²/g and below, good surface properties can be achieved. The average major axis length of the ferromagnetic metal powder is preferably equal to or greater than 10 nm and equal to or less than 150 nm, more preferably equal to or greater than 20 nm and equal to or less than 150 nm, and still more preferably, equal to or greater than 30 nm and equal to or less than 120 nm. The average acicular ratio of the ferromagnetic metal powder is preferably equal to or greater than 3 and equal to or less than 15. The σₛ of the ferromagnetic metal powder is preferably 100 to 180 A·m²/kg, more preferably 110 to 170 A·m²/kg. The coercivity of the ferromagnetic metal powder is preferably 2,000 to 3,500 Oe (about 160 to 280 kA/m), more preferably 2,200 to 3,000 Oe (about 176 to 240 kA/m). For details of the ferromagnetic metal powder suitable for use in the present invention, reference can be made to paragraphs [0038] to [003417] of Japanese Unexamined Patent Publication (KOKAI) No. 2009-54270.

(ii) Additives

Additives can be added as needed to the magnetic layer and nonmagnetic layer, described further below. Examples of the additives are abrasives, lubricants, dispersants, dispersion adjuvants, antimildew agents, antistatic agents, oxidation inhibitors, and solvents. For specific details on these additives, reference can be made to paragraphs [0043], [0049], and [0050] of Japanese Unexamined Patent Publication (KOKAI) No. 2009-54270. The types and quantities of the additives employed in the present invention can be varied as needed between the magnetic layer and the nonmagnetic layer, described further below. All or part of the additives employed in the present invention can be added in any step during the manufacturing of the coating liquid for the magnetic layer or nonmagnetic layer. For example, there are cases in which the additives are mixed with the ferromagnetic powder prior to the kneading step; cases in which they are added in the step of kneading the ferromagnetic powder, binder, and solvent; cases in which they are added during the dispersing step; cases when they are added following dispersion; and cases where they are added immediately prior to coating.

Of these, in the present invention, the magnetic layer can contain additives in the form of granular substances comprised of materials differing from the nonmagnetic filler. The inorganic powders that are commonly added as abrasives can be employed as granular substances. The abrasives that are contained in the magnetic layer in the present invention refer to granular substances of higher Mohs' hardness than the nonmagnetic filler contained in the same layer. For example, the Mohs' hardness of silica particles is 7. Thus, in a magnetic layer containing silica particles as nonmagnetic filler, a granular substance with a Mohs' hardness exceeding 7 would correspond to an abrasive. Incorporating an abrasive into the magnetic layer can increase the abrasiveness of the magnetic layer and eliminate material adhering to the head. From the perspective of increasing the abrasiveness of the magnetic layer, it is desirable to employ an inorganic powder with a Mohs' hardness of greater than 8, preferably a Mohs' hardness of equal to or higher than 9, as the abrasive. The maximum value of the Mohs' hardness is diamond, at 10. Specific examples are alumina (Al₂O₃), silicon carbide, boron carbide (B₄C), TiC, cerium oxide, zirconium oxide (ZrO₂), and diamond powder. Of these, alumina, silicon carbide, and diamond are desirable. These inorganic powders may be of any shape, including acicular, spherical, or cubic. The presence of an angular portion in the shape is desirable to enhance abrasiveness. Although it is conceivable to employ the inorganic powder employed as abrasive in this manner to form protrusions on the surface of the magnetic layer and enhance friction characteristics, when magnetic layer surface protrusions are formed in a quantity capable of maintaining the friction characteristics with most protrusions formed by abrasive, the abrasive power becomes excessive and head damage becomes pronounced. In addition, it becomes difficult to maintain friction characteristics when protrusions are formed with abrasive within a range that does not greatly damage the head. Accordingly, in the present invention, it is desirable to employ a nonmagnetic filler and abrasive in combination. From the perspective of not imparting major damage to the head with abrasive, the average particle diameter of the abrasive is desirably 10 to 300 nm, preferably 30 to 250 nm, and more preferably, 50 to 200 nm. The quantity added is desirably 1 to 20 weight parts, preferably 2 to 15 weight parts, and more preferably, 3 to 10 weight parts, per 100 weight parts of ferromagnetic powder. From the perspective of reducing head abrasion, the average particle diameter of the abrasive is desirable smaller than the average particle diameter of the nonmagnetic filler.

(iii) Binder

In the present invention, conventionally known thermoplastic resins, thermosetting resins, reactive resins, and mixtures thereof are examples of binders used in the magnetic layer and the nonmagnetic layer, described further below. For details, reference can be made to paragraphs [0044] to [0049] in Japanese Unexamined Patent Publication (KOKAI) No. 2009-54270, for example. As set forth above, the composite elastic modulus measured on the surface of the magnetic layer can be controlled by the binder employed. In the magnetic layer, the quantity of binder that is added is desirably 5 to 30 weight parts per 100 weight parts of ferromagnetic powder, and in the nonmagnetic layer, it is desirably 10 to 20 weight parts per 100 weight parts of nonmagnetic powder. A curing agent such as a polyisocyanate compound can also be employed with the binder. The quantity employed can be suitably determined.

The nonmagnetic layer and magnetic layer can be formed by simultaneous multilayer coating (wet-on-wet) in which the magnetic layer coating liquid is applied while the nonmagnetic layer coating liquid is still wet, or by sequential multilayer coating (wet-on-dry) in which the nonmagnetic layer coating liquid is dried before the magnetic layer coating liquid is applied. For the details of these coating methods, reference can be made to paragraph [0077] in Japanese Unexamined Patent Publication (KOKAI) No. 2009-54270. To form a suitable quantity of effective protrusions to enhance friction characteristics on the surface of the magnetic layer, it is desirable for the quantity of nonmagnetic filler and abrasive components in the magnetic layer that sink into the nonmagnetic layer to be small. From this perspective, sequential multilayer coating is desirable.

### Nonmagnetic Layer

The magnetic tape of the present invention comprises a nonmagnetic layer containing a nonmagnetic powder and a binder between the nonmagnetic support and the magnetic layer. The nonmagnetic powder contained in the nonmagnetic layer can be selected from inorganic compounds such as metal oxides, metal carbonates, metal sulfates, metal nitrides, metal carbides, metal sulfides and the like. Examples of inorganic compounds are α-alumina having an α-conversion rate of equal to or greater than 90 percent, β-alumina, γ-alumina, θ-alumina silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate due to their narrow particle distribution and numerous means of imparting functions. Even more preferred is titanium dioxide and α-iron oxide. The average particle diameter of these nonmagnetic powders preferably ranges from 5 to 50 nm, as set forth above. The specific surface area of the nonmagnetic powder preferably ranges from 1 to 100 m²/g, more preferably from 5 to 80 m²/g, further preferably from 10 to 75 m²/g. For the nonmagnetic powder suitable for use in the nonmagnetic layer, reference can be made to paragraphs [0051] to [0053] of Japanese Unexamined Patent Publication (KOKAI) No. 2009-54270. The nonmagnetic layer can contain known additives.

Binder resins, lubricants, dispersing agents, and other additives, solvents, dispersion methods, and the like suited to the magnetic layer may be adopted to the nonmagnetic layer. In particular, known techniques for the quantity and type of binder resin and the quantity and type of additives and dispersing agents employed in the magnetic layer may be adopted thereto.

### Nonmagnetic Support

A known film such as a biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. As set forth above, in terms of the surface roughness of the nonmagnetic support that can be employed in the present invention, a support with a centerline average surface roughness Ra of the surface on which the nonmagnetic layer is provided as measured by an optical three-dimensional profilometer falling within a range of 0.1 to 1.5 nm is desirable when the nonmagnetic layer is directly formed on the nonmagnetic support. Additionally, as set forth above, when employing a radiation-curable resin with a high leveling effect to form an undercoating layer and reduce the waviness of the surface of the magnetic layer, the centerline average surface roughness Ra as measured by an optical three-dimensional profilometer on the surface of the nonmagnetic support on which the undercoating layer is provided desirably falls within a range of 0.1 to 2.5 nm, preferably within a range of 0.1 to 1.5 nm. Further, as set forth above, the composite elastic modulus measured on the surface of the magnetic layer can be controlled by means of the mechanical characteristics of the nonmagnetic support.

### Backcoat Layer

Generally, more stringent repeat running properties are required for in magnetic tapes for use in recording computer data than in audio and video tapes. To maintain such high storage stability, a backcoat layer can be provided on the opposite surface of the nonmagnetic support from the surface on which the magnetic layer is provided. The backcoat layer coating liquid can be formed by dispersing particulate components such as abrasive and antistatic agents along with binder in an organic solvent. Various inorganic pigments and carbon black can be employed as particulate components. Examples of binders that can be employed, either singly or in combination, are nitrocellulose, phenoxy resin, vinyl chloride resin, and polyurethane.

### Layer Structure

In the magnetic recording medium of the present invention, the thickness of the nonmagnetic support desirably ranges from 3 to 10 μm. The thickness of the above backcoat layer is, for example, 0.1 to 1.0 μm, and desirably 0.2 to 0.8 μm.

The thicknesses of the magnetic layer and the nonmagnetic layer in the present invention are as set forth above. The nonmagnetic layer is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT (100 G), or a coercivity of equal to or less than 7.96 kA/m (100 Oe), it being preferable not to have a residual magnetic flux density or coercivity at all.

### Manufacturing Method

The steps for manufacturing coating liquids for forming the various layers such as the magnetic layer and the nonmagnetic layer desirably include at least a kneading step, dispersing step, and mixing steps provided as needed before and after these steps. Each of these steps may be divided into two or more stages. All of the starting materials such as the ferromagnetic powder, nonmagnetic powder, binder, carbon black, abrasives, antistatic agents, lubricants, solvents and the like that are employed in the present invention can be added at the beginning or part way through any of the steps. Individual starting materials can be divided into smaller quantities and added in two or more increments. For example, the polyurethane can be divided into small quantities and incorporated during the kneading step, dispersing step, and after the dispersing step to adjust the viscosity.

To prepare coating liquids for forming the various layers, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274, which are expressly incorporated herein by reference in their entirety. Further, glass beads may be employed to disperse the coating liquids for magnetic and nonmagnetic layers. Other than glass beads, dispersing media with a high specific gravity such as zirconia beads, titania beads, and steel beads are suitable for use. The particle diameter and fill ratio of these dispersing media can be optimized for use. A known dispersing device may be employed.

The coating machine used to apply the coating liquids for the magnetic layer, nonmagnetic layer, and backcoat layer can be an air doctor coater, blade coater, rod coater, extrusion coater, air knife coater, squeeze coater, dip coater, reverse roll coater, transfer roll coater, gravure coater, kiss coater, cast coater, spray coater, spin coater or the like. Reference can be made to the “Most Recent Coating Techniques” (May 31, 1983) released by the Sogo Gijutsu Center (Ltd.), which is expressly incorporated herein by reference in its entirety, for these coating machines. Following the coating step, the medium can be subjected to various post-processing, such as processing to orient the magnetic layer, processing to smoothen the surface (calendering), and thermoprocessing. Post-processing can be conducted by known methods. The calendering pressure, for example, is 200 to 500 kN/m, desirably 250 to 350 kN/m. The calendering temperature is, for example, 70 to 120° C., desirably 80 to 100° C. And the calendering rate is, for example, 50 to 300 m/min, desirably 100 to 200 m/min. The coating layers on the magnetic layer side in the magnetic tape of the present invention can undergo less plastic deformation than in conventional media, reducing sinking of the nonmagnetic filler in the magnetic layer and back transfer. On the other hand, little shape change can be achieved by calendering. However, suitable means (for example, use of a smooth nonmagnetic support and formation of the undercoating layer) can be adopted to compensate calendaring to reduce the waviness of the surface of the magnetic layer, thereby yielding a magnetic tape with low spacing variation despite little change in the shape achieved by calendering the coating layers on the magnetic layer side.

Normally, the magnetic tape is subjected to a heat treatment to improve dimensional stability in the use environment, promote curing of the magnetic layer, backcoat layer, and the like to which a thermosetting curing agent has been added, and the like. The temperature of such heat treatment is desirably suitably adjusted based on the objective, and can fall within a range of 50 to 80° C., for example. To enhance productivity, the heat treatment is desirably conducted after winding the product into a roll shape on a core-shaped member, or with the magnetic tape, prior to being cut into tape form, being wound into a roll form on a core-shaped member. The above calendering can be conducted before or after heat treating the magnetic tape, or both before and after the heat treatment. Conventionally, when the heat treatment is conducted in a roll form as set forth above, there is a pronounced tendency for back transfer to occur. However, in the present invention as set forth above, plastic deformation of the coating layers on the magnetic layer side can be reduced. Thus, even when subjected to heat treatment in a roll form, a magnetic tape can be obtained with little back transfer and little dropout.

The magnetic tape obtained can be cut to desired size with a cutter, punch, or the like for use.

The magnetic tape of the present invention as set forth above can exhibit little dropout or spacing variation and afford good running durability, making it suitable for use as a high-capacity data backup tape, of which high reliability is required for extended periods.

### EXAMPLES

The present invention will be described in detail below based on Examples. However, the present invention is not limited to the examples. The “parts” given in Examples is weight parts unless specifically stated otherwise.

### Example 1

Magnetic layer coating liquid

| (Magnetic liquid) | | |
|---|---|---|
| Barium ferrite (average particle diameter 20 nm) | 100 | parts |
| SO₃Na group-containing polyurethane resin | 14 | parts |
| (molecular weight: 70,000; SO₃Na groups: 0.2 meq/g) | | |
| Cyclohexanone | 150 | parts |
| Methyl ethyl ketone | 150 | parts |
| (Abrasive liquid) | | |
| Abrasive: diamond powder (average particle diameter: | 5 | parts |
| 80 nm) | | |
| Sulfonate group-containing polyurethane resin | 0.3 | part |
| (molecular weight: 70,000; SO₃Na groups: 0.2 meq/g) | | |
| Cyclohexanone | 27 | parts |
| (Silica sol) | | |
| Colloidal silica | 2 | parts |
| (average particle diameter: 100 nm, | | |
| coefficient of variation of particle size distribution: | | |
| 20 percent) | | |
| Methyl ethyl ketone | 1.4 | parts |
| (Other components) | | |
| Stearic acid | 2 | parts |
| Butyl stearate | 6 | parts |
| Polyisocyanate | 2.5 | parts |
| (Coronate L, made by Nippon Polyurethane Industry Co., | | |
| Ltd.) | | |
| (Solvents adding during finishing) | | |
| Cyclohexanone | 200 | parts |
| Methyl ethyl ketone | 200 | parts |

Nonmagnetic layer coating liquid

| | | |
|---|---|---|
| Nonmagnetic inorganic powder: α-iron oxide | 100 | parts |
| Average major axis length: 10 nm | | |
| Average acicular ratio: 1.9 | | |
| Specific surface area by BET method: 75 m²/g | | |
| Carbon black | 20 | parts |
| Average particle diameter 20 nm | | |
| SO₃Na group-containing polyurethane resin | 18 | parts |
| (molecular weight: 70,000, SO₃Na groups: 0.2 meq/g) | | |
| Stearic acid | 1 | part |
| Cyclohexanone | 300 | parts |
| Methyl ethyl ketone | 300 | parts |

Backcoat layer coating liquid

| | | |
|---|---|---|
| Nonmagnetic inorganic powder: α-iron oxide | 80 | parts |
| Average major axis length: 0.15 μm | | |
| Average acicular ratio: 7 | | |
| Specific surface area by BET method: 52 m²/g | | |
| Carbon black | 20 | parts |
| Average particle diameter 20 nm | | |
| Vinyl chloride copolymer | 13 | parts |
| Sulfonate group-containing polyurethane resin | 6 | parts |
| Phenyl phosphonic acid | 3 | parts |
| Cyclohexanone | 155 | parts |
| Methyl ethyl ketone | 155 | parts |
| Stearic acid | 3 | parts |
| Butyl stearate | 3 | parts |
| Polyisocyanate | 5 | parts |
| Cyclohexanone | 200 | parts |

The above magnetic liquid was dispersed for 24 hours in a batch-type vertical sand mill. Zirconia beads 0.5 mm in diameter were employed as a dispersion medium. The abrasive liquid was dispersed for 24 hours in a batch-type ultrasonic device (20 kHz, 300 W). The dispersions were mixed with the other components (silica sol, other components, and solvents added during finishing) and processed for 30 minutes in a batch-type ultrasonic device (20 kHz, 300 W). Subsequently, filtration was conducted with a filter having an average pore diameter of 0.5 μm to prepare a magnetic layer coating liquid.

A nonmagnetic layer coating liquid was prepared by dispersing the various components in a batch-type vertical sand mill for 24 hours employing zirconia beads 0.1 mm in diameter as a dispersion medium, and filtering the dispersion obtained with a filter having an average pore diameter of 0.5 μm.

A backcoat layer coating liquid was prepared as follows. The various components, excluding the lubricants (stearic acid and butyl stearate), polyisocyanate and 200 parts of cyclohexanone, were kneaded and diluted in an open kneader. A horizontal bead mill disperser was then used to conduct 12 passes of dispersion processing using zirconia beads 1 mm in diameter at a bead fill rate of 80 percent, a rotor tip perimeter speed of 10 m/s, and a single pass residence time of 2 minutes. Subsequently, the remaining components were added to the dispersion and the mixture was stirred with a dissolver. The dispersion obtained was then filtered with a filter having an average particle diameter of 1 μm.

The nonmagnetic layer coating liquid was applied and dried to a thickness of 100 nm on the surface (centerline surface roughness (Ra value) as measured by the method described further below: 0.5 nm) of a polyethylene naphthalate support (Young's modulus in the width direction: 8 GPa, Young's modulus in the lengthwise direction: 6 GPa) 5 μm in thickness, after which the magnetic layer coating liquid was applied thereover in a quantity calculated to yield a dry thickness of 70 nm. While the magnetic layer coating liquid was still wet, a magnetic field with an intensity of 0.3 T was applied in a direction perpendicular to the coating surface to conduct vertical orientation processing, after which the magnetic layer coating liquid was dried. The backcoat layer coating liquid was then applied and dried to a thickness of 0.4 nm on the opposite side of the support.

Subsequently, a calender comprised of metal rolls was used to conduct a surface smoothing treatment at a rate of 100 m/min, a linear pressure of 300 kg/cm, and a temperature of 100° C., after which the product was heat treated for 36 hours in a dry environment at 70° C. Following heat treatment, the product was slit to a ½ inch width to obtain a magnetic tape.

### Example 2

A magnetic tape was prepared in the same manner as in Example 1 with the exception that the thickness of the magnetic layer was changed to 100 nm.

### Example 3

A magnetic tape was prepared in the same manner as in Example 1 with the exception that the thickness of the magnetic layer was changed to 60 nm.

### Example 4

A magnetic tape was prepared in the same manner as in Example 1 with the exception that the thickness of the nonmagnetic layer was changed to 50 nm.

### Example 5

A magnetic tape was prepared in the same manner as in Example 1 with the exception that the thickness of the nonmagnetic layer was changed to 200 nm.

### Example 6

A magnetic tape was prepared in the same manner as in Example 1 with the exception that the support was changed to a polyethylene naphthalate support with a centerline surface roughness (Ra value) of the surface on the side on which the magnetic layer was formed as measured by the method set forth further below of 1.3 nm.

### Example 7

A magnetic tape was prepared in the same manner as in Example 1 with the exceptions that colloidal silica with an average particle diameter of 200 nm was employed and the thickness of the magnetic layer was changed to 170 nm.

### Example 8

A magnetic tape was prepared in the same manner as in Example 1 with the exceptions that colloidal silica with an average particle diameter of 50 nm was employed and the thickness of the magnetic layer was changed to 50 nm.

### Example 9

A magnetic tape was prepared in the same manner as in Example 1 with the exception that the thickness of the magnetic layer was changed to 50 nm.

### Example 10

A magnetic tape was prepared in the same manner as in Example 1 with the exceptions that colloidal silica with an average particle diameter of 50 nm was employed and the thickness of the magnetic layer was changed to 30 nm.

### Example 11

A magnetic tape was prepared in the same manner as in Example 1 with the exceptions that colloidal silica with an average particle diameter of 200 nm was employed, the thickness of the magnetic layer was changed to 200 nm, and the concentration of SO₃Na groups in the polyurethane resin employed in the nonmagnetic layer coating liquid was changed to 0.3 meq/g.

### Example 12

A magnetic tape was prepared in the same manner as in Example 1 with the following exceptions. The support was changed to a polyethylene naphthalate support with a centerline surface roughness (Ra value) of 1.5 nm, as measured by the method set forth further below, on the surface on the side on which the magnetic layer was formed. Prior to coating the nonmagnetic layer, an intermediate layer (undercoating layer) coating liquid comprised of 100 parts of dipentaerythritol hexacrylate (DPE6A made by Kyoei Kagaku Kogyo Co., Ltd.) and 400 parts of methyl ethyl ketone was coated and dried on the surface of the support to a dry thickness of 0.15 μm and irradiated with an electron beam at an acceleration voltage of 125 keV and a radiant energy of 20 kGy to cure the coating layer and form a radiation-cured layer. Subsequently, a nonmagnetic layer was formed on the surface of the radiation-cured layer.

### Example 13

A magnetic tape was prepared in the same manner as in Example 1 with the exception that the nonmagnetic filler employed was changed from colloidal silica to organic polymer particles (average particle diameter: 100 nm, coefficient of variation of particle size distribution: 40 percent), and dispersed together with the magnetic liquid components.

### Example 14

A magnetic tape was prepared in the same manner as in Example 1 with the exception that the nonmagnetic filler employed was changed from colloidal silica to organic polymer particles (average particle diameter: 100 nm, coefficient of variation of particle size distribution: 50 percent), and dispersed together with the magnetic liquid components.

### Comparative Example 1

A magnetic tape was prepared in the same manner as in Example 1 with the exception that colloidal silica with an average particle diameter of 200 nm was employed.

### Comparative Example 2

A magnetic tape was prepared in the same manner as in Example 1 with the exception that colloidal silica with an average particle diameter of 50 nm was employed.

### Comparative Example 3

A magnetic tape was prepared in the same manner as in Example 1 with the exception that the thickness of the nonmagnetic layer was changed to 25 nm.

### Comparative Example 4

A magnetic tape was prepared in the same manner as in Example 1 with the exception that the thickness of the nonmagnetic layer was changed to 250 nm.

### Comparative Example 5

A magnetic tape was prepared in the same manner as in Example 1 with the exception that a support of polyethylene naphthalate with a centerline surface roughness (Ra value) of 2.5 nm, as measured by the method set forth further below, on the surface on the side on which the magnetic layer was formed was employed.

### Comparative Example 6

A magnetic tape was prepared in the same manner as in Example 1 with the following exceptions. The support was changed to a polyethylene naphthalate support with a centerline surface roughness (Ra value) of 2.0 nm, as measured by the method set forth further below, on the surface on the side on which the magnetic layer was formed. Prior to coating the nonmagnetic layer, an intermediate layer (undercoating layer) coating liquid comprised of 100 parts of dipentaerythritol hexacrylate (DPE6A made by Kyoei Kagaku Kogyo Co., Ltd.) and 400 parts of methyl ethyl ketone was coated and dried on the surface of the support to a dry thickness of 0.5 μm and irradiated with an electron beam at an acceleration voltage of 125 keV and a radiant energy of 20 kGy to cure the coating layer and form a radiation-cured layer. Subsequently, a nonmagnetic layer was formed on the surface of the radiation-cured layer.

### Comparative Example 7

A magnetic tape was prepared in the same manner as in Example 1 with the exception that the material of the support was changed to polyaramid (Young's modulus in the width direction: 16 GPa, Young's modulus in the lengthwise direction: 10 GPa).

### Comparative Example 8

A magnetic tape was prepared in the same manner as in Example 1 with the exceptions that colloidal silica with an average particle diameter of 300 nm was employed, the thickness of the magnetic layer was changed to 250 nm, and the content of SO₃Na groups of the polyurethane resin employed in the nonmagnetic layer coating liquid was changed to 0.3 meq/g.

### Comparative Example 9

A magnetic tape was prepared in the same manner as in Example 1 with the exceptions that colloidal silica with an average particle diameter of 50 nm was employed and the thickness of the magnetic layer was changed to 25 nm.

### Comparative Example 10

A magnetic tape was prepared in the same manner as in Comparative Example 6 with the exception that the thickness of the nonmagnetic layer was changed to 250 nm.

### Evaluation Methods

(a) Centerline Average Surface Roughness Ra as Measured by Optical Three-Dimensional Profilometer

The centerline average surface roughness Ra of the surface of the magnetic layer was measured for an area of 350 gm by 260 μm using a non-contact optical profilometer (device: New View 5022 made by Zygo) with a 20-fold object lens. The centerline average surface roughness Ra of the nonmagnetic support was a value measured by the same method.

(b) Composite Elastic Modulus

The composite elastic modulus was obtained by single pressing measurement using a spherical indenter (tip R: 1.3 μm) made of diamond using a Tribo Indenter made by Hysitron Inc. The average value of three measurements at a pressing (unloading) time of 11 seconds up to the maximum pressing depth for a maximum pressing depth of 100 nm was adopted as the composite elastic modulus measured on the magnetic layer surface.

(c) SNR Measurement

A signal recorded with a recording head (head saturation flux density Bs: 1.8 T, head gap: 0.2 μm) in a reel tester with a tape feed rate of 4 m/minute was reproduced with a reproduction head (track width: 0.2 μm, sh-sh spacing: 0.08 μm). The recording signal output was set to 250 kfci and the signal-to-noise ratio for the cumulative noise from −0.1 MHz to −1 MHz in the vicinity of 250 kfci was adopted as the SNR.

(d) Measurement of Dropout

The same recording and reproduction were conducted as in the above SNR measurement and drops in output of equal to or more than 60 percent at a magnitude of equal to or more than 0.5 μm per meter of tape feed length were counted as dropouts.

(e) Measurement of the Coefficient of Friction

The surface of the magnetic tape was repeatedly slid back and forth 100 times with a load of 100 g against a cylindrical SUS rod with a centerline average surface roughness Ra of 5 nm as measured by AFM at a speed of 10 mm/s to obtain the coefficient of friction.

The results are given in Table 1. A SNR of equal to or higher than 2.0, equal to or fewer than 600 dropouts, and a coefficient of friction of equal to or less than 0.35 (desirably equal to or less than 0.30) indicate desirable electromagnetic characteristics and friction characteristics in tapes for high-capacity data backup.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 |
|---|---|---|---|---|---|---|---|---|---|---|---|---|---|
| Average particle | 100 | 100 | 100 | 100 | 100 | 100 | 200 | 50 | 100 | 50 | 200 | 100 | 100 |
| diameter of nonmagnetic | | | | | | | | | | | | | (Or- |
| filler (average primary | | | | | | | | | | | | | ganic |
| particle diameter)φ/nm | | | | | | | | | | | | | polymer |
| | | | | | | | | | | | | | particle) |
| Coefficient of variation | 20 | 20 | 20 | 20 | 20 | 20 | 20 | 20 | 20 | 20 | 20 | 20 | 40 |
| of particle size distri- | | | | | | | | | | | | | |
| bution of nonmagnetic | | | | | | | | | | | | | |
| filler/% | | | | | | | | | | | | | |
| Magnetic layer thickness | 70 | 100 | 60 | 70 | 70 | 70 | 170 | 50 | 50 | 30 | 200 | 70 | 70 |
| t/nm | | | | | | | | | | | | | |
| φ/t | 1.4 | 1.0 | 1.7 | 1.4 | 1.4 | 1.4 | 1.2 | 1.0 | 2.0 | 1.7 | 1.0 | 1.4 | 1.4 |
| Nonmagnetic layer | 100 | 100 | 100 | 50 | 200 | 100 | 100 | 100 | 100 | 100 | 100 | 100 | 100 |
| thickness/nm | | | | | | | | | | | | | |
| Composite elastic | 7.1 | 7.3 | 6.9 | 6.5 | 7.5 | 7.0 | 7.6 | 6.8 | 6.8 | 6.6 | 7.0 | 6.4 | 7.1 |
| modulus/Gpa | | | | | | | | | | | | | |
| Ra of support surface | 0.5 | 0.5 | 0.5 | 0.5 | 0.5 | 1.3 | 0.5 | 0.5 | 0.5 | 0.5 | 0.5 | 1.5 | 0.5 |
| (on the side on which | | | | | | | | | | | | | |
| magnetic layer was | | | | | | | | | | | | | |
| formed)/nm | | | | | | | | | | | | | |
| Ra of the magnetic | 0.6 | 0.7 | 0.6 | 0.5 | 0.9 | 1.4 | 0.9 | 0.6 | 0.6 | 0.6 | 0.6 | 0.6 | 0.6 |
| layer surface/nm | | | | | | | | | | | | | |
| Undercoating layer | None | None | None | None | None | None | None | None | None | None | None | Present | None |
| SNRsk/dB | 3.5 | 3.0 | 3.0 | 3.5 | 3.0 | 2.5 | 2.2 | 2.0 | 2.7 | 2.5 | 2.0 | 3.5 | 3.5 |
| Dropout | 100 | 110 | 110 | 120 | 100 | 500 | 500 | 500 | 200 | 200 | 600 | 100 | 100 |
| 200kfci 70% remain | | | | | | | | | | | | | |
| Coefficient of friction | 0.20 | 0.30 | 0.20 | 0.20 | 0.30 | 0.20 | 0.20 | 0.30 | 0.20 | 0.20 | 0.30 | 0.25 | 0.22 |

| | | Comp. | Comp. | Comp. | Comp. | Comp. | Comp. | Comp. | Comp. | Comp. | Comp. |
|---|---|---|---|---|---|---|---|---|---|---|---|
| | Ex. 14 | Ex. 1 | Ex. 2 | Ex. 3 | Ex. 4 | Ex. 5 | Ex. 6 | Ex. 7 | Ex. 8 | Ex. 9 | Ex. 10 |
| Average particle | 100 | 200 | 50 | 100 | 100 | 100 | 100 | 100 | 300 | 50 | 100 |
| diameter of nonmagnetic | (Or- | | | | | | | | | | |
| filler (average primary | ganic | | | | | | | | | | |
| particle diameter)φ/nm | polymer | | | | | | | | | | |
| | particle) | | | | | | | | | | |
| Coefficient of variation | 50 | 20 | 20 | 20 | 20 | 20 | 20 | 20 | 20 | 20 | 20 |
| of particle size distri- | | | | | | | | | | | |
| bution of nonmagnetic | | | | | | | | | | | |
| filler/% | | | | | | | | | | | |
| Magnetic layer thickness | 70 | 70 | 70 | 70 | 70 | 70 | 70 | 70 | 250 | 25 | 70 |
| t/nm | | | | | | | | | | | |
| φ/t | 1.4 | 2.9 | 0.7 | 1.4 | 1.4 | 1.4 | 1.4 | 1.4 | 1.2 | 2.0 | 1.4 |
| Nonmagnetic layer | 100 | 100 | 100 | 25 | 250 | 100 | 100 | 100 | 100 | 100 | 250 |
| thickness/nm | | | | | | | | | | | |
| Composite elastic | 7.1 | 7.0 | 7.0 | 6.0 | 9.2 | 7.1 | 5.0 | 11.0 | 8.0 | 6.2 | 6.5 |
| modulus/Gpa | | | | | | | | | | | |
| Ra of support surface | 0.5 | 0.5 | 0.5 | 0.5 | 0.5 | 2.5 | 2.0 | 0.6 | 0.5 | 0.5 | 2.0 |
| (on the side on which | | | | | | | | | | | |
| magnetic layer was | | | | | | | | | | | |
| formed)/nm | | | | | | | | | | | |
| Ra of the magnetic | 0.6 | 0.6 | 0.7 | 0.6 | 1 | 2.7 | 0.6 | 0.8 | 1.2 | 0.6 | 1 |
| layer surface/nm | | | | | | | | | | | |
| Undercoating layer | None | None | None | None | None | None | Present | None | None | None | Present |
| SNRsk/dB | 3.5 | −2.0 | −2.0 | −2 | −2 | −4 | −2.0 | 1.5 | −5.0 | 0.0 | −1 |
| Dropout | 100 | 100 | 100 | 100 | 15000 | 10000 | 100 | 1500 | 1000 | 1000 | 120 |
| 200kfci 70% remain | | | | | | | | | | | |
| Coefficient of friction | 0.35 | 0.15 | 0.70 or | 0.15 | 0.70 or | 0.40 | 0.60 | 0.60 | 0.60 | 0.20 | 0.70 or |
| | | | more | | more | | | | | | more |

### Evaluation Results

As shown in Table 1, the magnetic tapes of Examples which satisfied items (1) to (5) above exhibited SNRs of equal to or higher than 2.0, equal to or fewer than 600 dropouts, and coefficients of friction of equal to or less than 0.35, and thus exhibited both desirable electromagnetic characteristics and friction characteristics as high-capacity data backup tapes. Among them, the fact that magnetic tapes of Examples 1 to 5, 12, and 13 exhibited fewer dropouts and higher SNRs than the other Examples was attributed to effective control of back transfer and reduction of spacing loss.

By contrast, the reasons the magnetic tapes of Comparative Examples 1 to 10 exhibited poorer results than the Examples in one or more evaluation category were thought to be as follows.

### Comparative Example 1

Since φ/t exceeded 2.0, the number of protrusions of nonmagnetic filler from the surface of the magnetic layer was excessive and the spacing loss was great, compromising the SNR.

### Comparative Example 2

Since φ/t was less than 1.0, there were insufficient protrusions of nonmagnetic filler on the surface of the magnetic layer. As a result, the coefficient of friction increased when the head and magnetic layer surface slide against each other, and sliding characteristics deteriorated, lowering the SNR.

### Comparative Example 3

The thickness of the nonmagnetic layer was less than 30 nm and an adequate output could not be achieved, so the SNR dropped.

### Comparative Example 4

The nonmagnetic layer was thick (in excess of 200 nm) and the composite elastic modulus measured on the surface of the magnetic layer exceeded 8.0 GPa. Thus, there were numerous portions undergoing plastic deformation in the coating layers on the magnetic layer side, and the amount of plastic deformation was great. As a result, the SNR, dropout, and coefficient of friction were all poorer than those of the Examples.

### Comparative Example 5

The Ra of the surface of the magnetic layer was high (in excess of 1.5 nm) and there was pronounced spacing variation due to waviness of the magnetic layer surface, resulting in a large drop in the SNR. The reason for the high coefficient of friction was thought to be that the great waviness of the surface of the magnetic layer meant that only protrusions on the high portions of the waviness came into contact, and these protrusions ended up being shaved away. Further, due to variation in output caused by the great waviness of the surface of the magnetic layer, the Ra of the surface of the magnetic layer was thought to increase the number of dropouts because indentations over a certain range not counted as dropouts ended up being counted as dropouts.

### Comparative Example 6

The composite elastic modulus measured on the surface of the magnetic layer was less than 6.0 GPa and the nonmagnetic filler in the magnetic layer was not present as effective protrusions on the surface of the magnetic layer, causing a rise in friction and a drop in SNR.

### Comparative Example 7

The composite elastic modulus measured on the surface of the magnetic layer exceeded 8.0 GPa, so there was pronounced dropout due to back transfer. Further, protrusions contributing to enhancing friction characteristics during running were not present on the surface of the magnetic layer, increasing the coefficient of friction.

### Comparative Example 8

A thick magnetic layer (in excess of 200 nm) resulted in low output and a high coefficient of friction increased noise due to output variation, thereby greatly lowering the SNR. In Comparative Example 8, although φ/t was within the range of 1 to 2, the magnetic layer was thick (in excess of 200 nm), permitting the presence of coarse nonmagnetic filler. As a result, the number of particles of nonmagnetic filler decreased and a sufficient number of protrusions failed to form, which was thought to have caused in increase in the coefficient of friction. The reason for the increase in dropout was thought to be that the coarse nonmagnetic filler formed high protrusions on the surface of the magnetic layer and the fact that an adequate number of protrusions was not formed, resulting in output variation and a tendency to be affected by indentations.

### Comparative Example 9

The magnetic layer was thin (less than 30 nm) and adequate output was not achieved, resulting in a drop in SNR. In Comparative Example 9, the fact that the magnetic layer was thin was thought to result in relatively great variation in the thickness of the magnetic layer. As a result, output variation increased and indentations tended to have an effect, which was presumed to cause increased dropout.

### Comparative Example 10

The nonmagnetic layer was thick (in excess of 200 nm) and there were many portions undergoing plastic deformation. As a result, the nonmagnetic filler in the magnetic layer sank into the nonmagnetic layer, increasing the coefficient of friction and causing increased dropout due to back transfer. The low SNR was attributed to a high coefficient of friction.

The magnetic tape of the present invention is suitable as a computer backup tape.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior

What is claimed is:

1. A magnetic tape comprising, on one surface of a nonmagnetic support, a nonmagnetic layer containing a nonmagnetic powder and a binder, and thereon, a magnetic layer containing a ferromagnetic powder and a binder, wherein
the magnetic layer contains a nonmagnetic filler the average particle diameter φ of which satisfies relation (I) below with a thickness t of the magnetic layer:
1.0≦φ/t≦2.0 (I);
the thickness t of the magnetic layer ranges from 30 to 200 nm;
the nonmagnetic layer has a thickness ranging from 30 to 200 nm;
a composite elastic modulus as measured on a surface of the magnetic layer ranges from 6.0 to 8.0 GPa; and
a centerline average surface roughness Ra of the surface of the magnetic layer, as measured by an optical three-dimensional profilometer, ranges from 0.2 to 1.5 nm.

2. The magnetic tape according to claim 1, wherein the nonmagnetic filler is selected from the group consisting of an inorganic oxide particle and an organic polymer particle.

3. The magnetic tape according to claim 1, wherein the nonmagnetic filler is a colloidal particle.

4. The magnetic tape according to claim 1, wherein the nonmagnetic filler is a silica colloidal particle.

5. The magnetic tape according to claim 1, wherein the magnetic layer contains the nonmagnetic filler in a quantity ranging from 0.3 to 20 weight parts per 100 weight parts of the ferromagnetic powder.

6. The magnetic tape according to claim 1, wherein the magnetic layer further contains a granular substance which is different from the nonmagnetic filler.

7. The magnetic tape according to claim 1, wherein a centerline average surface roughness Ra of the surface of the nonmagnetic support over which the magnetic layer is present, as measured by an optical three-dimensional profilometer, ranges from 0.1 to 1.5 nm.

8. The magnetic tape according to claim 1, which comprises a radiation-cured layer between the nonmagnetic layer and the nonmagnetic support.

9. The magnetic tape according to claim 1, wherein an average particle size of the nonmagnetic powder contained in the nonmagnetic layer ranges from 5 to 50 nm.

10. The magnetic tape according to claim 1, wherein the binder contained in the nonmagnetic layer comprises a functional group selected from the group consisting of a sulfonic acid group and a sulfonate group.

11. The magnetic tape according to claim 10, wherein a concentration of the functional group of the binder contained in the nonmagnetic layer ranges from 0.04 to 0.5 meq/g.

12. The magnetic tape according to claim 1, which comprises a backcoat layer on the other surface of the nonmagnetic support.
